(19) United States
(12) Patent Application Publication
(10) Pub. No.: US 2018/0346301 A1
(43) Pub. Date: Dec. 6, 2018

(54) SYSTEM AND METHOD FOR OPERATOR CALIBRATED IMPLEMENT POSITION DISPLAY

(71) Applicant: Deere & Company, Moline, IL (US)

(72) Inventors: David Myers, Dubuque, IA (US); Kevin W. Campbell, Dubuque, IA (US); Adam J. Sobkowiak, Dubuque, IA (US); Aaron R. Kenkel, Dubuque, IA (US); Kyle E. Leinaar, Dubuque, IA (US); Chad Stapes, Dubuque, IA (US)

(21) Appl. No.: 15/613,766

(22) Filed: Jun. 5, 2017

(51) Int. Cl. B66F 9/075; B60K 35/00; B66F 9/22

(52) U.S. Cl. CPC B66F 9/0755; B60K 2350/1056; B66F 9/22; B60K 35/00

(57) ABSTRACT

System and method for an operator calibrated implement position display system for a loader work vehicle. The loader work vehicle has a boom and an implement each positionable by hydraulic cylinders actuated by a hydraulic circuit. The system includes a source of position data for the boom and the implement. The system also includes a controller that determines an operator defined level position and stores the operator defined level position as a calibrated level position for the implement. The controller also determines, based on the position data, a current position of the implement and compares the current position of the implement with the calibrated level position. The controller generates operator interface data for rendering on a display associated with the loader work vehicle that graphically illustrates the current position of the implement relative to the calibrated level position.

### CROSS-REFERENCE TO RELATED APPLICATION(S)

Not applicable.

### STATEMENT OF FEDERALLY SPONSORED RESEARCH OR DEVELOPMENT

Not applicable.

### FIELD OF THE DISCLOSURE

This disclosure relates to work vehicles and to an operator calibrated implement position display.

### BACKGROUND OF THE DISCLOSURE

In the construction industry, various work machines, such as loaders, may be utilized in lifting and moving various materials. In certain instances, a loader may include a pair of forks movably coupled by a boom to a frame. One or more hydraulic cylinders are coupled to the boom and/or the forks to move the forks between positions relative to the frame to lift and move the various materials.

In certain instances, the operator may be unable to view the position of the forks due to a linkage of the loader and the position of the forks. The operator may also be unable to view whether the forks are at a desired angular position for lifting and moving materials. The inability of the operator to view the tips of the forks and to determine whether the forks are at the desired position may reduce a productivity of the loader as the operator may need to leave the cabin to visually inspect the position of the forks.

### SUMMARY OF THE DISCLOSURE

The disclosure provides a system and method for an operator calibrated implement position display that displays a position of an implement relative to an operator defined level position.

In one aspect the disclosure provides an operator calibrated implement position display system for a loader work vehicle. The loader work vehicle has a boom and an implement each positionable by hydraulic cylinders actuated by a hydraulic circuit. The system includes a source of position data for the boom and the implement. The system also includes a controller that determines an operator defined level position and stores the operator defined level position as a calibrated level position for the implement. The controller also determines, based on the position data, a current position of the implement and compares the current position of the implement with the calibrated level position. The controller generates operator interface data for rendering on a display associated with the loader work vehicle that graphically illustrates the current position of the implement relative to the calibrated level position.

In another aspect the disclosure provides a method for an operator calibrated implement position display system for a loader work vehicle. The loader work vehicle has a boom and an implement each positionable by hydraulic cylinders actuated by a hydraulic circuit. The method comprises determining, by a processor, an operator defined level position and receiving position data for the boom and the implement. The method includes determining, by the processor, based on the position data and a kinematic model for the implement, a current position of the implement and comparing, by the processor, the current position of the implement to the operator defined level position. The method includes generating operator interface data for rendering on a display associated with the loader work vehicle that graphically illustrates the current position of the implement relative to the calibrated level position.

In yet another aspect the disclosure provides an operator calibrated implement position display system for a loader work vehicle. The loader work vehicle has a boom and an implement each positionable by hydraulic cylinders actuated by a hydraulic circuit. The system includes a source of position data for the boom and the implement. The system also includes a controller that determines an operator defined level position and stores the operator defined level position as a calibrated level position for the implement. The controller also determines, based on the position data, a current position of the implement and compares the current position of the implement with the calibrated level position. The controller determines an angular difference between the current position and the calibrated level position based on the comparison. The controller generates operator interface data for rendering on a display associated with the loader work vehicle that graphically illustrates the current position of the implement relative to the calibrated level position.

The details of one or more embodiments are set forth in the accompanying drawings and the description below. Other features and advantages will become apparent from the description, the drawings, and the claims.

### BRIEF DESCRIPTION OF THE DRAWINGS

FIG. 1 is a perspective view of an example work vehicle in the form of a wheel loader in which the disclosed operator calibrated implement position display system and method may be used;

FIG. 2 is a side view of a boom assembly and implement of the work vehicle of FIG. 1, with the implement in a first, operator defined level positon;

FIG. 3 is a dataflow diagram illustrating an example operator calibrated implement position display system in accordance with various embodiments;

FIGS. 3A-3B are exemplary calibration operator interfaces generated by the operator calibrated implement position display system in accordance with various embodiments;

FIGS. 4-6 are exemplary operator interfaces generated by the operator calibrated implement position display system in accordance with various embodiments;

FIGS. 7-9 are exemplary operator interfaces generated by the operator calibrated implement position display system in accordance with various embodiments;

FIG. 10 is a flowchart illustrating an example calibration method of the disclosed operator calibrated implement position display system of FIG. 1 in accordance with various embodiments;

FIG. 11 is a flowchart illustrating an example method of the disclosed operator calibrated implement position display system of FIG. 1 for rendering the operator interfaces of FIGS. 4-6 in accordance with various embodiments; and

FIG. 12 is a flowchart illustrating an example method of the disclosed operator calibrated implement position display system of FIG. 1 for rendering the operator interfaces of FIGS. 7-9 in accordance with various embodiments.

Like reference symbols in the various drawings indicate like elements.

### DETAILED DESCRIPTION

The following describes one or more example embodiments of the disclosed system and method, as shown in the accompanying figures of the drawings described briefly above. Various modifications to the example embodiments may be contemplated by one of skill in the art.

As used herein, unless otherwise limited or modified, lists with elements that are separated by conjunctive terms (e.g., “and”) and that are also preceded by the phrase “one or more of” or “at least one of” indicate configurations or arrangements that potentially include individual elements of the list, or any combination thereof. For example, “at least one of A, B, and C” or “one or more of A, B, and C” indicates the possibilities of only A, only B, only C, or any combination of two or more of A, B, and C (e.g., A and B; B and C; A and C; or A, B, and C).

As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the loader described herein is merely one example embodiment of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

The following describes one or more example implementations of the disclosed system and method for improving the productivity of a loader work vehicle by displaying on a display a position of an implement of the loader work vehicle relative to an operator calibrated level position, as shown in the accompanying figures of the drawings described briefly above. Generally, the disclosed control systems and methods (and work vehicles in which they are implemented) provide for improved productivity in a loading operation as compared to conventional systems by automatically displaying a position of the implement relative to the operator calibrated level position to assist the operator in loading materials onto the implement. By displaying the position of the implement relative to the operator calibrated level position, the operator is able to view the position of the implement relative to the operator's desired level position for loading even when the operator cannot view the implement, without having to leave a cab of the loader work vehicle. Thus, productivity and efficiency of the loading operation is improved by the disclosed operator calibrated implement position display systems and methods.

The disclosed operator calibrated implement position display system may be used to generate a first operator interface or a second operator interface for rendering on a display of a human-machine interface of the loader work vehicle. In one example, the first operator interface graphically and/or textually displays whether the forks are at the operator defined level position, whether the forks are raised or whether the forks are lowered. The first operator interface also textually indicates an angular position difference from the level position, in degrees, for example. This enables the operator to easily identify the angle of the forks relative to the operator's defined level position, thereby improving productivity of the loader work vehicle.

In another example, the second operator interface graphically and/or textually displays the current angular position relative to the operator defined level position on a graphical level indicator. The disclosed operator calibrated implement position display generates a fill for the graphical level indicator based on the current angular position of the forks relative to the operator's defined level position. This also enables the operator to easily identify the angle of the forks relative to the operator's defined level position, thereby improving productivity of the loader work vehicle.

Generally, in order to define the operator calibrated level position, a controller of the loader work vehicle determines whether an implement has been coupled to the loader work vehicle. Based on this determination, the controller generates a calibration operator interface, which prompts the operator to select an implement coupled to the work vehicle, and to set an implement offset for the particular implement. Once the operator has moved the implement to a desired level position, the operator provides input to a human-machine interface associated with the work vehicle, for example, presses and/or holds a button disposed in a cab of the work vehicle, to indicate that the current angular position of the implement is the operator's desired level position. Once the operator selects the current angular position as the level position, the controller sets this position as the calibrated level position and saves it in a datastore associated with the controller.

During the use of the implement, such as the forks, the controller determines the current angular position. For each angular position, the controller determines whether the forks are level. In one example, if the controller determines the forks are not level, the controller determines whether the forks are raised or lowered based on an angular difference between the current angular position and the calibrated level position. In this example, the controller generates the first operator interface based on these determinations.

In another example, if the forks are not level, the controller determines whether the forks are level, within a first position range between the calibrated level position and a second position range, within the second position range, within a third position range between the calibrated level position and the fourth position range, and within the fourth position range by comparing an angular difference between the current angular position and the calibrated level position to predefined thresholds. Based on the comparison, the controller generates the second operator interface with the fill data that corresponds to ii the current angular position of the forks.

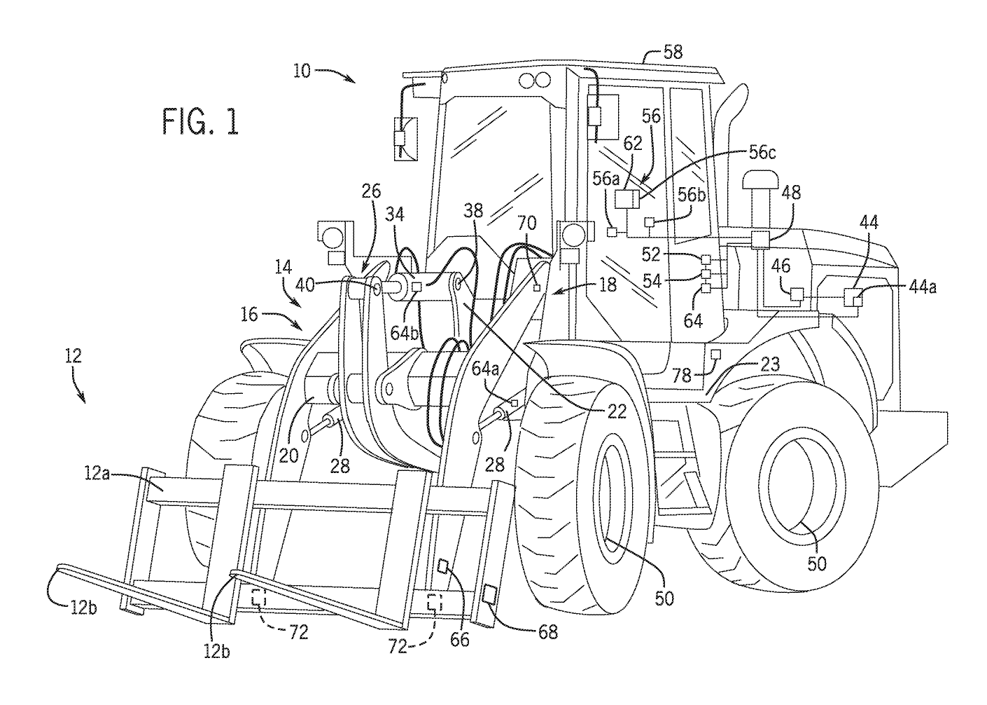

As noted above, the disclosed operator calibrated implement position display system may be utilized with regard to various machines or work vehicles with work implements, including loaders and other machines for lifting and moving various materials, for example, various machines used in the agriculture, construction and forestry industries. Referring to FIG. 1, in some embodiments, the disclosed operator calibrated implement position display system may be used with a wheel or track loader work vehicle 10 to assist in a loading operation with an implement 12, which in this example is a pair of forks. By displaying the position of the implement 12, the cycle time of the loading operation may be improved, thereby increasing the productivity of the operation of the loader work vehicle 10. It will be understood that the configuration of the loader work vehicle 10 is presented as an example only. In this regard, the disclosed operator calibrated implement position display system may be implemented with a fork attachment fixed or removably coupled to an otherwise non-loader work vehicle, such as a tractor.

In the embodiment depicted, the implement 12 is pivotally mounted to a boom assembly 14. In this example, the forks are mounted on a frame 12a and each includes tips 12b. The forks cooperate to lift and carry various materials. In one example, the boom assembly 14 includes a first boom 16 and a second boom 18, which are interconnected via a crossbeam 20 to operate in parallel. Each of the first boom 16 and the second boom 18 are coupled to a frame portion 22 of a frame 23 of the loader work vehicle 10 at a first end, and are coupled at a second end to the implement 12 via a respective one of a first pivot linkage and a second pivot linkage (not shown).

One or more hydraulic cylinders 28 are mounted to the frame portion 22 and to the boom assembly 14, such that the hydraulic cylinders 28 may be driven or actuated in order to move or raise the boom assembly 14 relative to the loader work vehicle 10. Generally, the boom assembly 14 includes two hydraulic cylinders 28, one coupled between the frame portion 22 and the first boom 16; and one coupled between the frame portion 22 and the second boom 18. It should be noted, however, that the loader work vehicle 10 may have any number of hydraulic cylinders, such as one, three, etc. Each of the hydraulic cylinders 28 includes an end mounted to the frame portion 22 at a pin (not shown) and an end mounted to the respective one of the first boom 16 and the second boom 18 at a pin (not shown). Upon activation of the hydraulic cylinders 28, the boom assembly 14 may be moved between various positions to elevate the boom assembly 14, and thus, the implement 12 relative to the frame 23 of the loader work vehicle 10.

One or more hydraulic cylinders 34 are mounted to the frame portion 22 and a ii pivot linkage 26. Generally, the loader work vehicle 10 includes a single hydraulic cylinder 34 associated with the pivot linkage 26. In this example, the hydraulic cylinder 34 includes an end mounted to the frame portion 22 at a pin 38 and an end mounted to the pivot linkage 26 at a pin 40. Upon activation of the hydraulic cylinder 34, the implement 12 may be moved between various positions to pivot the implement 12 relative to the boom assembly 14. Thus, in the embodiment depicted, the implement 12 is pivotable about the boom assembly 14 by the hydraulic cylinder 34. In other configurations, other movements of the forks or implement may be possible. Further, in some embodiments, a different number or configuration of hydraulic cylinders or other actuators may be used.

It will be understood that the configuration of the implement 12 is presented as an example only. In this regard, a hoist boom (e.g. the boom assembly 14) may be generally viewed as a boom that is pivotally attached to a vehicle frame, and that is also pivotally attached to an implement or end effector. Similarly, a pivoting linkage (e.g., the pivot linkage 26) may be generally viewed as a pin or similar feature effecting pivotal attachment of an implement 12 (e.g. forks) to a vehicle frame. In this light, a tilt actuator (e.g., the hydraulic cylinder 34) may be generally viewed as an actuator for pivoting an implement with respect to a hoist boom, and the hoist actuator (e.g. the hydraulic cylinders 28) may be generally viewed as an actuator for pivoting a hoist boom with respect to a vehicle frame.

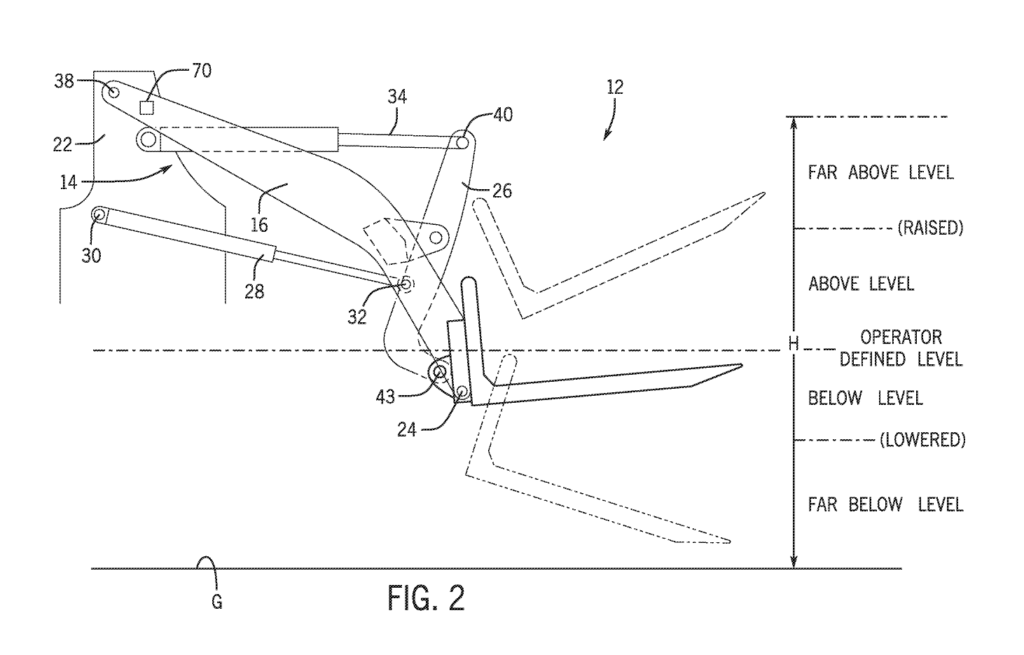

The implement 12 is coupled to the pivot linkage 26 via a coupling pin (not shown). The coupling pin cooperates with the pivot linkage 26 to enable the movement of the implement 12 upon activation of the hydraulic cylinder 34. The implement 12 is movable upon activation of the hydraulic cylinder 34 between a first, operator defined level position (FIG. 2), a second, lowered or far below level position (FIG. 1), a third, raised or above level position (FIG. 2) and various positions relative to the operator defined level position. In the first, level position, the implement 12 is capable of receiving various materials. In the second, lowered or far below level position, the implement 12 is lowered downward relative to the frame 23 of the loader work vehicle 10 by the actuation of the hydraulic cylinders 28 such that the implement 12 may place the various materials on a ground surface G, for example (FIG. 2). In the third, raised or above level position, the implement 12 is raised upward relative to the frame 23 by the actuation of the hydraulic cylinders 28 such that the implement 12 retains the various materials.

With reference to FIG. 2, FIG. 2 illustrates the various positions of the implement 12. The positions of the implement 12 are within predefined position ranges. In this example, the implement 12 is movable from the operator defined level position to a first position range between the operator defined level position and a second position range. The first position range corresponds with a lowered or below level position of the implement 12. In one example, the first position range is defined as a position of the implement 12 that is about 1 degree to 3 degrees below the operator defined level position. Stated another way, the current position of the implement 12 is determined to be in the below level position if the current position is different than the operator defined level position by about −1 degree to −3 degrees. In one example, the first position range includes two sub-ranges that correspond with a first below level position and a second below level position. In one example, the first below level position is defined as a position of the implement 12 that is about 1 degree to 2 degrees below (about −1 degree to −2 degrees) the operator defined level position; and the second below level position is defined as a position of the implement 12 that is about 2 degrees to 3 degrees below (about −2 degrees to −3 degrees) the operator defined level position.

The implement 12 is also movable to the second position range. The second position range corresponds with a lowered or far below level position of the implement 12. Thus, the implement 12 is at a lowered position in both the first position range and the second position range. The implement 12 is at a below level position in the first position range, and is at a far below level position in the second position range. In one example, the second position range is defined as a position of the implement 12 that is about 3 degrees to 6 degrees (or more) below the operator defined level position. Stated another way, the current position of the implement 12 is determined to be in the far below level position if the current position is different than the operator defined level position by about −3 degrees to −6 degrees (or more). In one example, the second position range includes three sub-ranges that correspond with a first far below level position, a second far below level position and a third far below level position. In one example, the first far below level position is defined as a position of the implement 12 that is about 3 degrees to 4 degrees below (about −3 degrees to −4 degrees) the operator defined level position; the second far below level position is defined as a position of the implement 12 that is about 4 degrees to 5 degrees below (about −4 degrees to −5 degrees) the operator defined level position; and the third far below level position is defined as a position of the implement 12 that is about 5 degrees to 6 degrees (or more) below (about −5 degrees to −6 degrees) the operator defined level position. It should be noted that the above percentages that define the position ranges are based on a length of the implement 12, and the values of these percentages may be user-configurable, if desired, to account for an implement having a different length. Thus, based on a difference between the current angular position of the implement and the operator defined level position, the position of ii the implement 12 may be classified into one of the position ranges.

The implement 12 is also movable from the operator defined level position to a third position range between the operator defined level position and a fourth position range. The third position range corresponds with a raised or above level position of the implement 12. In one example, the third position range is defined as a position of the implement 12 that is about 1 degree to 3 degrees above the operator defined level position. Stated another way, the current position of the implement 12 is determined to be in the above level position if the current position is different than the operator defined level position by about +1 degree to +3 degrees. In one example, the third position range includes two sub-ranges that correspond with a first above level position and a second above level position. In one example, the first above level position is defined as a position of the implement 12 that is about 1 degree to 2 degrees above (about +1 degree to +2 degrees) the operator defined level position; and the second above level position is defined as a position of the implement 12 that is about 2 degrees to 3 degrees above (about +2 degrees to +3 degrees) the operator defined level position.

The implement 12 is also movable to the fourth position range. The fourth position range corresponds with a raised or far above level position of the implement 12. Thus, the implement 12 is at a raised position in both the third position range and the fourth position range. The implement 12 is at an above level position in the third position range, and is at a far above level position in the fourth position range. In one example, the fourth position range is defined as a position of the implement 12 that is about 3 degrees to 6 degrees above the operator defined level position. Stated another way, the current position of the implement 12 is determined to be in the far above level position if the current position is different than the operator defined level position by about +3 degrees to +6 degrees. In one example, the fourth position range includes three sub-ranges that correspond with a first far above level position, a second far above level position and a third far above level position. In one example, the first far above level position is defined as a position of the implement 12 that is about 3 degrees to 4 degrees above (about +3 degrees to +4 degrees) the operator defined level position; the second far above level position is defined as a position of the implement 12 that is about 4 degrees to 5 degrees above (about +4 degrees to +5 degrees) the operator defined level position; and the third far above level position is defined as a position of the implement 12 that is about 5 degrees to 6 degrees (or more) above (about +5 degrees to +6 degrees or more) the operator defined level position.

The loader work vehicle 10 includes a propulsion system that supplies power to move the loader work vehicle 10. The propulsion system includes an engine 44 and a transmission 46. The engine 44 supplies power to a transmission 46. In one example, the engine 44 is an internal combustion engine, such as the diesel engine, that is controlled by an engine control module 44a. It should be noted that the use of an internal combustion engine is merely an example, as the propulsion device can be a fuel cell, an electric motor, a hybrid-gas electric motor, etc.

The transmission 46 transfers the power from the engine 44 to a suitable drivetrain coupled to one or more driven wheels 50 (and tires) of the loader work vehicle 10 to enable the loader work vehicle 10 to move. As is generally known, the transmission 46 can include a suitable gear transmission, which can be operated in a variety of ranges containing one or more gears.

The loader work vehicle 10 also includes one or more pumps 52, which may be driven by the engine 44 of the loader work vehicle 10. Flow from the pumps 52 may be routed through various control valves 54 and various conduits (e.g., flexible hoses and lines) in order to drive the hydraulic cylinders 28, 34. Flow from the pumps 52 may also power various other components of the loader work vehicle 10. The flow from the pumps 52 may be controlled in various ways (e.g., through control of the various control valves 54), in order to cause movement of the hydraulic cylinders 28, 34, and thus, the implement 12 relative to the loader work vehicle 10. In this way, for example, a movement of the boom assembly 14 and/or implement 12 between various positions relative to the frame 23 of the loader work vehicle 10 may be implemented by various control signals to the pumps 52, control valves 54, and so on.

Generally, the controller 48 (or multiple controllers) may be provided, for control of various aspects of the operation of the loader work vehicle 10, in general. The controller 48 (or others) may be configured as a computing device with associated processor devices and memory architectures, as a hard-wired computing circuit (or circuits), as a programmable circuit, as a hydraulic, electrical or electro-hydraulic controller, or otherwise. As such, the controller 48 may be configured to execute various computational and control functionality with respect to the loader work vehicle 10 (or other machinery). In some embodiments, the controller 48 may be configured to receive input signals in various formats (e.g., as hydraulic signals, voltage signals, current signals, and so on), and to output command signals in various formats (e.g., as hydraulic signals, voltage signals, current signals, mechanical movements, and so on). In some embodiments, the controller 48 (or a portion thereof) may be configured as an assembly of hydraulic components (e.g., valves, flow lines, pistons and cylinders, and so on), such that control of various devices (e.g., pumps or motors) may be effected with, and based upon, hydraulic, mechanical, or other signals and movements.

The controller 48 may be in electronic, hydraulic, mechanical, or other communication with various other systems or devices of the loader work vehicle 10 (or other machinery). For example, the controller 48 may be in electronic or hydraulic communication with various actuators, sensors, and other devices within (or outside of) the loader work vehicle 10, including various devices associated with the pumps 52, control valves 54, and so on. The controller 48 may communicate with other systems or devices (including other controllers) in various known ways, including via a CAN bus (not shown) of the loader work vehicle 10, via wireless or hydraulic communication means, or otherwise. An example location for the controller 48 is depicted in FIG. 1. It will be understood, however, that other locations are possible including other locations on the loader work vehicle 10, or various remote locations.

In some embodiments, the controller 48 may be configured to receive input commands and to interact with an operator via a human-machine interface 56, which may be disposed inside a cab 58 of the loader work vehicle 10 for easy access by the operator. The human-machine interface 56 may be configured in a variety of ways. In some embodiments, the human-machine interface 56 may include one or more joysticks 56a, various switches or levers, one or more buttons 56b, a touchscreen interface 56c that may be overlaid on a display 62, a keyboard, an audible device, a microphone associated with a speech recognition system, or various other human-machine interface devices. In one example, the one or more joysticks 56a may receive an input, such as a request to change a gear range of the transmission 46. The one or more buttons 56b may receive an input, such as a request to set a current position of the implement 12, such as the forks, as a user or operator defined level position. Generally, the operator depresses one of the buttons 56b for a predefined threshold period of time, such as about 1.0 seconds to 2.0 seconds, to set a current position of the implement 12 as the operator defined level position. The touchscreen interface 56c may receive input, such as a type of implement 12, such as the forks, coupled to the loader work vehicle 10. Alternatively, the touchscreen interface 56c may also receive the input that sets the current position of the implement 12 as the operator or user defined level position. The display 62 comprises any suitable technology for displaying information, including, but not limited to, a liquid crystal display (LCD), organic light emitting diode (OLED), plasma, or a cathode ray tube (CRT). In this example, the display 62 is an electronic display capable of graphically displaying one or more operator interfaces under the control of the controller 48. Those skilled in the art may realize other techniques to implement the display 62 in the loader work vehicle 10.

Various sensors may also be provided to observe various conditions associated with the loader work vehicle 10. In some embodiments, various sensors 64 (e.g., pressure, flow or other sensors) may be disposed near the pumps 52 and control valves 54, or elsewhere on the loader work vehicle 10. For example, sensors 64 may include one or more pressure sensors that observe a pressure within the hydraulic circuit, such as a pressure associated with at least one of the one or more hydraulic cylinders 28, 34. The sensors 64 may also observe a pressure associated with the hydraulic pumps 52. As a further example, one or more sensors 64a may be coupled to a respective one of the hydraulic cylinders 28 to observe a pressure within the hydraulic cylinders 28 and generate sensor signals based thereon. Further, one or more sensors 64b may be coupled to the hydraulic cylinder 34 to observe a pressure within the hydraulic cylinder 34 and generate sensor signals based thereon.

In some embodiments, various sensors may be disposed near the implement 12. For example, sensors 66 (e.g. inertial measurement sensors) may be coupled near the implement 12 in order to observe or measure parameters including the acceleration of the boom assembly 14 near the implement 12 and so on. Thus, the sensors 66 observe an acceleration of the boom assembly 14 near the implement 12 and generate sensor signals thereon, which may indicate if the boom assembly 14 and/or implement 12 are decelerating or accelerating.

In some embodiments, various sensors 68 (e.g., rotary angular position sensor 68) may be configured to detect the angular orientation of the implement 12 relative to the boom assembly 14, or detect various other indicators of the current orientation or position of the implement 12. Thus, the sensors 68 generally include implement position sensors that indicate a position of the implement 12 relative to the boom assembly 14. Other sensors may also (or alternatively) be used. For example, a linear position or displacement sensors may be utilized in place of the rotary angular position sensors 68 to determine the length of the hydraulic cylinder 34 relative to the boom assembly 14. In such a case, the detected linear position or displacement may provide alternative (or additional) indicators of the current position of the implement 12.

Various sensors 70 (e.g., angular position sensor 70) may be configured to detect the angular orientation of the boom assembly 14 relative to the frame portion 22, or detect various other indicators of the current orientation or position of the boom assembly 14 relative to the frame 23 of the loader work vehicle 10. Thus, the sensors 70 generally include boom position sensors that indicate a position of the boom assembly 14 relative to the frame 23 of the loader work vehicle 10. Other sensors may also (or alternatively) be used. For example, a linear position or displacement sensors may be utilized in place of the angular position sensors 70 to determine the length of the hydraulic cylinders 28 ii relative to the frame portion 22. In such a case, the detected linear position or displacement may provide alternative (or additional) indicators of the current position of the boom assembly 14.

With reference to FIG. 1, sensors 72 may also be disposed on or near the frame 23 of the loader work vehicle 10 in order to measure various parameters associated with the loader work vehicle 10. For example, sensors 72 may be coupled to the first pivot linkage and/or the second pivot linkage associated with the hydraulic cylinders 28 and/or the pivot linkage associated with the hydraulic cylinder 34. The sensors 72 observe a coupling of an implement 12, such as the forks, to the first boom 16, the second boom 18 and the pivot linkage 26 and generate sensor signals based thereon. The sensor signals, when processed by the controller 48, indicate whether a new implement has been attached to the loader work vehicle 10.

The various components noted above (or others) may be utilized to display a position of the implement 12 on the display 62 of the human-machine interface 56. Accordingly, these components may be viewed as forming part of the operator calibrated implement position display system for the loader work vehicle 10. Each of the sensors 64-72 and the human-machine interface 56 are in communication with the controller 48 via a suitable communication architecture, such as a CAN bus.

In various embodiments, the controller 48 outputs one or more operator interfaces for rendering on the display 62 associated with the loader work vehicle 10 based on one or more of the sensor signals received from the sensors 64-72, input received from the human-machine interface 56, and further based on the operator calibrated implement position display system and method of the present disclosure.

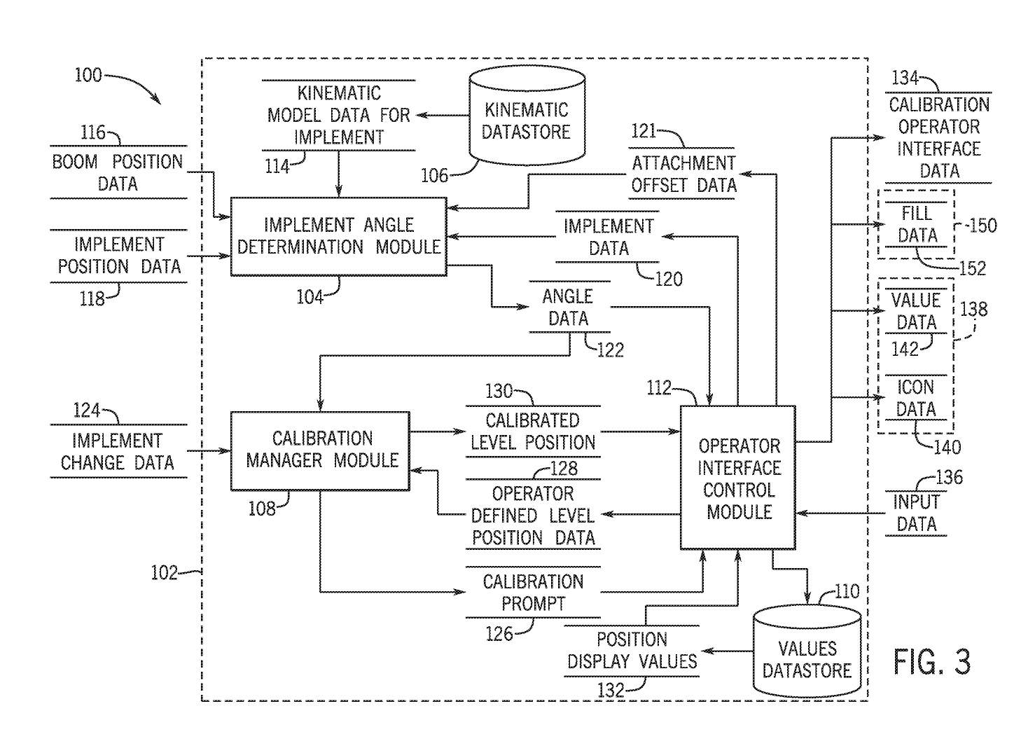

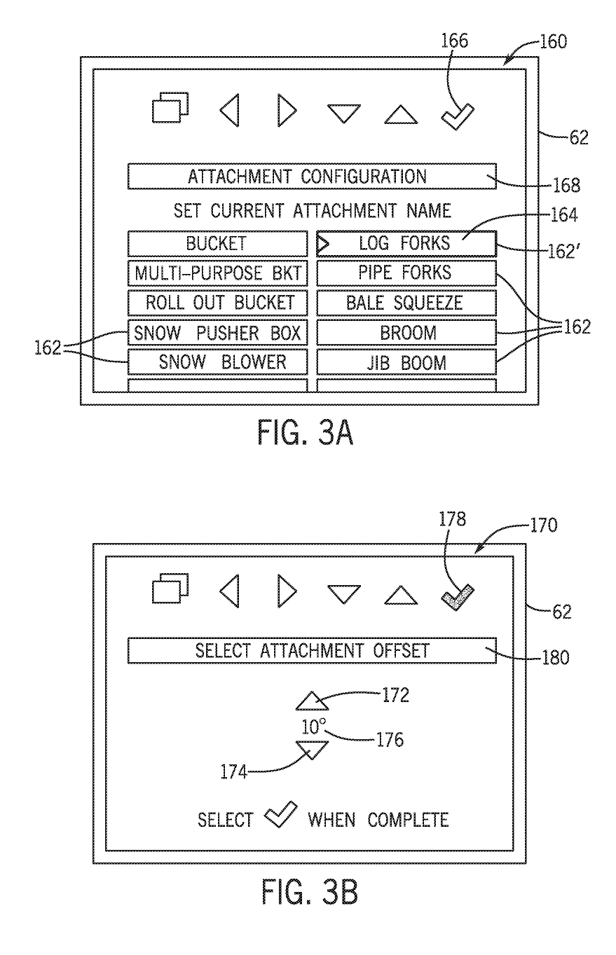

Referring now also to FIG. 3, a dataflow diagram illustrates various embodiments of an operator calibrated implement position display system 100 for the loader work vehicle 10, which may be embedded within a control module 102 associated with the controller 48. Various embodiments of the operator calibrated implement position display system 100 according to the present disclosure can include any number of sub-modules embedded within the control module 102. As can be appreciated, the sub-modules shown in FIG. 3 can be combined and/or further partitioned to similarly output one or more operator interfaces for rendering on the display 62 to the human-machine interface 56. Inputs to the operator calibrated implement position display system 100 are received from the sensors 64-72 (FIG. 1), received from the human-machine interface 56 (FIG. 1), received from other control modules (not shown) associated with the loader work vehicle 10, and/or determined/modeled by other sub-modules (not shown) within the controller 48. In various embodiments, the control module 102 includes an implement angle determination module 104, a kinematic datastore 106, a calibration manager module 108, a values datastore 110 and a user interface (UI) control module 112.

The kinematic datastore 106 stores kinematic model data 114 for each implement, such as the implement 12, which may be coupled to the loader work vehicle 10. The kinematic model data 114 provides geometric relationships that govern the movement of the particular implement by the first boom 16, the second boom 18 and the pivot linkage 26 of the loader work vehicle 10. In addition, the kinematic model data 114 also provides geometric relationships that govern the movement of the particular implement based on how the implement is coupled to the loader work vehicle 10. In this regard, depending upon the type of implement, the implement may be coupled to the loader work vehicle 10 an angular position or offset that is different than an angular position of another implement due to the position of the coupling member, such as pins, for example, that attach the implement to the loader work vehicle 10. Thus, for each implement 12 that may be attached to the loader work vehicle 10 by a respective coupling member, respective kinematic model data 114 is stored in the kinematic datastore 106.

The implement angle determination module 104 receives as input boom position data 116. The boom position data 116 comprises the sensor data or sensor signals from the sensor 70. The implement angle determination module 104 processes the sensor signals in the boom position data 116 and determines an angular position of the first boom 16 and the second boom 18.

The implement angle determination module 104 also receives as input implement position data 118. The implement position data 118 comprises the sensor data or sensor signals from the sensor 68. The implement angle determination module 104 processes the sensor signals in the implement position data 118 and determines an angular position of the implement, such as the implement 12.

The implement angle determination module 104 also receives as input implement data 120. In one example, the implement data 120 is received from the operator interface control module 112, as input received from the human-machine interface 56. The implement data 120 is the type of implement coupled to the loader work vehicle 10.

The implement angle determination module 104 also receives as input attachment offset data 121. In one example, the attachment offset data 121 is received from the operator interface control module 112, as input received from the human-machine interface 56. Generally, the attachment offset data 121 is an angular offset determined for the attachment of a particular implement 12 to the loader work vehicle 10. In this regard, certain implements 12 may be coupled to the loader work vehicle 10 at different angles, due to how the implement 12 is attached or coupled to the loader work vehicle 10. In certain embodiments, the attachment offset data 121 includes an angular offset for a coupler used to couple the implement 12 to the loader work vehicle 10.

Based on the implement data 120, the implement angle determination module 104 receives as input the kinematic model data 114 for the type of implement. Thus, in this example, the implement angle determination module 104 retrieves the kinematic model data 114 for the forks being coupled to the loader work vehicle 10. Based on the determined angular position of the implement 12, the determined angular position of the first boom 16, the determined angular position of the second boom 18 and the angular offset received for the attachment of the implement 12 from the attachment offset data 121, the implement angle determination module 104 processes the kinematic model data 114 to determine an angle of the implement 12, in this example, an angle of the forks. The implement angle determination module 104 sets the determined angle of the implement 12 as angle data 122 for the calibration manager module 108 and the operator interface control module 112.

The calibration manager module 108 receives as input implement change data 124. The implement change data 124 comprises the sensor data or sensor signals from the sensors 72. The implement angle determination module 104 processes the sensor signals in the implement change data 124 and determines whether a new implement has been coupled to the loader work vehicle 10. If true, the calibration manager module 108 sets a calibration prompt 126 for the operator interface control module 112. The calibration prompt 126 indicates that the implement 12 coupled to the loader work vehicle 10 has changed.

The calibration manager module 108 also receives as input operator defined level position data 128 from the operator interface control module 112. The operator defined level position data 128 is a command to set the current position of the implement 12, such as the forks, as the level position. Based on the receipt of the operator defined level position data 128, the calibration manager module 108 receives as input the angle data 122. The calibration manager module 108 sets the angle data 122 as a calibrated level position 130 for the operator interface control module 112. The calibrated level position 130 is the operator defined level position for the angular position of the implement 12. In certain instances, the operator defined level position is not a true level position, but rather, is an operator preferred position, which is offset from a determined actual position for a true level position of the implement 12 relative to a horizontal plane. Thus, the calibrated level position 130 is generally an offset position from a true level position for the implement 12 relative to a horizontal plane.

The values datastore 110 stores data indicating one or more position display values 132 associated with a movement of the implement 12. In one example, the values datastore 110 is populated with the calibrated level position 130 received by the operator interface control module 112 from the calibration manager module 108. The values datastore 110 also stores one or more threshold ranges that correlate a position of the implement relative to the calibrated level position to one of the position ranges. In this example, the thresholds include, but are not limited to, a threshold range for the first position range, the second position range, the third position range and the fourth position range. In one example, each of the threshold ranges may be a range of values that correlate a difference between the stored calibrated level position and the current angular position of the implement 12, such as the current angular position for the forks, to a position of the implement 12 for rendering on the display 62. Thus, the position display values 132 provide the calibrated level position 130 and one or more threshold range values for angular positions of the implement 12 relative to the calibrated level position 130.

For example, the threshold range for the first position range (lowered or below level) is about 1 degrees to 3 degrees below the calibrated level position. In one example, the values datastore 110 also stores threshold ranges for the two sub-ranges that correspond with the first below level position and the second below level position. The threshold for the first below level position is about 1 degree to 2 degrees below (about −1 degree to −2 degrees) the calibrated level position; and the threshold for the second below level position is about 2 degrees to 3 degrees below (about −2 degrees to −3 degrees) the calibrated level position.

In one example, the threshold range for the second position range (lowered or far below level) is about 3 degrees to 6 degrees below the calibrated level position. In one example, the values datastore 110 also stores threshold ranges for the three sub-ranges that correspond with the first far below level position, the second far below level position and the third far below level position. The threshold range for the first far below level position is about 3 degrees to 4 degrees below (about −3 degrees to −4 degrees) the calibrated level position; the threshold range for the second far below level position is about 4 degrees to 5 degrees below (about −4 degrees to −5 degrees) the calibrated level position; and the threshold range for the third far below level position is about 5 degrees to 6 degrees below (about −5 degrees to −6 degrees) the calibrated level position.

The threshold range for the third position range (raised or above level) is about +1 degree to +3 degrees above the calibrated level position. In one example, the values datastore 110 also stores threshold ranges for the two sub-ranges that correspond with ii the first above level position and the second above level position. In one example, the threshold range for the first above level position is about 1 degrees to 2 degrees above (about +1 degrees to +2 degrees) the calibrated level position; and the threshold range for the second above level position is about 2 degrees to 3 degrees above (about +2 degrees to +3 degrees) the calibrated level position.

The threshold range for the fourth position range (raised or far above level) is about +3 degrees to +6 degrees above the calibrated level position. In one example, the values datastore 110 also stores threshold ranges for the three sub-ranges that correspond with the first far above level position, the second far above level position and the third far above level position. In one example, the threshold range for the first far above level position is about 3 degrees to 4 degrees above (about +3 degrees to +4 degrees) the calibrated level position; the threshold range for the second far above level position is about 4 degrees to 5 degrees above (about +4 degrees to +5 degrees) the calibrated level position; and the threshold range for the third far above level position is about 5 degrees to 6 degrees above (about +5 degrees to +6 degrees) the calibrated level position.

The operator interface control module 112 receives as input the calibration prompt 126. Based on the calibration prompt 126, the operator interface control module 112 outputs calibration prompt operator interface data 134 for rendering one or more calibration prompt interfaces on the display 62. The calibration prompt operator interface data 134 is rendered on the display 62 to prompt the operator to select a type of implement 12 coupled to the loader work vehicle 10, and to prompt the operator to set the angular offset for the attachment of the implement 12.

With reference to FIG. 3A, an exemplary calibration prompt interface 160 generated by the operator interface control module 112 and rendered on the display 62 is shown. In this example, the calibration prompt interface 160 includes a plurality of operator-selectable buttons 162, which enable the operator to select the implement 12 coupled to the loader work vehicle 10. It should be noted that the calibration prompt interface 160 is not limited to the use of selectable buttons, rather, the calibration prompt interface 160 may also include a drop-down list, for example. Each of the buttons 162 includes a textual label 164, which provides a name of a particular implement 12 that may be coupled to the loader work vehicle 10. In one example, the operator may select a desired one of the buttons 162 to highlight the particular button, such as button 162′, and then select a confirmation button 166 to confirm the selection of the particular button 162. The selection of one of the buttons 162, via the operator's interaction with the touchscreen interface 56c, the joysticks, the buttons 56b, etc., for example, is received by ii the operator interface control module 112 and interpreted to set the implement data 120. The calibration prompt interface 160 may also include one or more textual description boxes 168, which provide instructions to the operator for interacting with the calibration prompt interface 160.

With reference to FIG. 3B, an exemplary calibration prompt interface 170 generated by the operator interface control module 112 and rendered on the display 62 is shown. In this example, the calibration prompt interface 170 enables the operator to set the attachment offset for the implement 12 based on how the implement 12 is coupled to the loader work vehicle 10. In one example, the calibration prompt interface 170 includes a first, up input arrow 172 spaced apart from a second, down input arrow 174. A numeric display box 176 is disposed between the up input arrow 172 and the down input arrow 174, and displays a range of degrees based on the input received to the up input arrow 172 and the down input arrow 174. Generally, the range of degrees is about negative 10 degrees to about positive 10 degrees. In one example, the operator may provide input to one or both of the up input arrow 172 and the down input arrow 174 to arrive at the selected degree displayed in the display box 176. The calibration prompt interface 170 may also include a confirmation button 178 to confirm the operator selected degree for the angular offset. The input to the calibration prompt interface 170 and the operator's selection of the confirmation button 178, via the operator's interaction with the touchscreen interface 56c, the joysticks, the buttons 56b, etc., for example, is received by the operator interface control module 112 and interpreted to set the selected degree for the angular offset as the attachment offset data 121. The calibration prompt interface 170 may also include one or more textual description boxes 180, which provide instructions to the operator for interacting with the calibration prompt interface 170.

The operator interface control module 112 also receives input data 136. The input data 136 comprises operator input to the human-machine interface 56, such as input received from the joysticks 56a, the buttons 56b and/or the touchscreen interface 56c. The operator interface control module 112 processes and interprets the input data 136 to determine whether an input was received that selected a type of implement 12, via the operator's interaction with the calibration prompt interface 160, for example. If true, the operator interface control module 112 sets the selected type of implement 12 received in the input data 136 as the implement data 120 for the implement angle determination module 104.

The operator interface control module 112 also processes and interprets the input data 136 to determine whether an input was received to set a current angular position of the implement 12 as the operator defined level position. In one example, the operator interface control module 112 processes the input data 136 to determine whether input has been received to one of the buttons 56b for setting the current angular position of the implement 12 as the operator defined level position. In this example, the operator interface control module 112 processes the input data 136 to determine whether input has been received to one of the buttons 56b for a predefined threshold period of time, such as 1.0 seconds to 2.0 seconds. If true, the operator interface control module 112 sets the operator defined level position data 128 for the calibration manager module 108.

The operator interface control module 112 also processes and interprets the input data 136 to determine whether an input was received to set the angular offset for the attachment of the implement 12, via the operator's interaction with the calibration prompt interface 170, for example. If true, the operator interface control module 112 sets the angular offset value received as the attachment offset data 121 for the implement angle determination module 104.

The operator interface control module 112 receives as input the calibrated level position 130. The operator interface control module 112 stores the calibrated level position 130 in the values datastore 110.

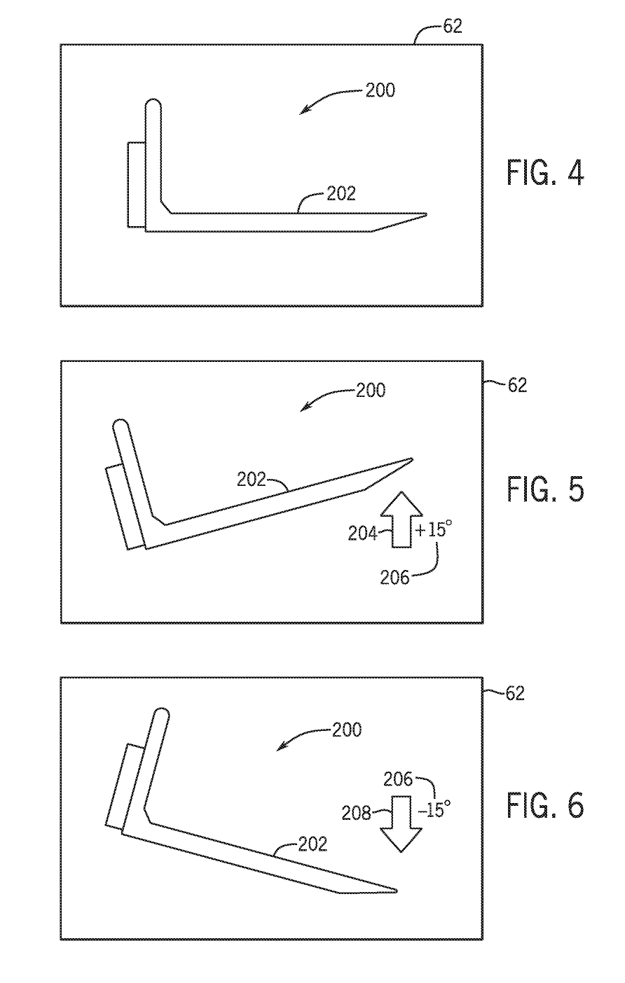

In one embodiment, the operator interface control module 112 also receives as input the angle data 122. Based on the angle data 122, the operator interface control module 112 retrieves the position display values 132, including the calibrated level position 130, from the values datastore 110. The operator interface control module 112 compares the angle data 122 to the calibrated level position 130 and determines whether the current angular position of the implement 12 is at the operator defined level position. In one example, the operator interface control module 112 subtracts the calibrated level position 130 from the received angle data 122 to determine an angular difference. If the implement 12 is determined to be level (within about ±1 degree), the operator interface control module 112 outputs first operator interface data 138, which graphically and/or textually indicates that the implement 12 is level. The first operator interface data 138 includes icon data 140 and value data 142 for rendering a first operator interface 200 (FIGS. 4-6) on the display 62. The icon data 140 is a command to render an icon or symbol of the implement at its current determined angular position and the value data 142 is a command to render an angular value for the current angular position of the implement 12. In this example, the icon data 140 comprises a command to render an icon of the implement 12 as level, and the value data 142 is a null value as the implement 12 is determined to be level.

The operator interface control module 112 also compares the angle data 122 to the calibrated level position 130 and determines whether the implement 12 is within the threshold range for the third position range or the fourth position range (the raised position), such as about +1 degree to about +6 degrees or more, as defined by the position display values 132. In one example, the operator interface control module 112 subtracts the calibrated level position 130 from the received angle data 122 to determine the angular difference. If the implement 12 is determined to be raised (positive angular difference within about +1 degree and about +6 degrees or more), the operator interface control module 112 outputs the first operator interface data 138, which graphically and/or textually indicates that the implement 12 is raised. The first operator interface data 138 includes the icon data 140 and the value data 142 for rendering the first operator interface 200 (FIGS. 4-6) on the display 62. In this example, the icon data 140 comprises a command to render the icon of the implement 12 as raised, and the value data 142 is the determined positive angular difference that the implement 12 is above the calibrated level position 130. The value data 142 may also include instructions to render a symbol, such as an arrow, which points upward, based on the determination that the implement 12 is raised.

The operator interface control module 112 also compares the angle data 122 to the calibrated level position 130 and determines whether the implement 12 is within the threshold range for the first position range or the second position range (the lowered position), such as about −1 degree to about −6 degrees or more, as defined by the position display values 132. In one example, the operator interface control module 112 subtracts the calibrated level position 130 from the received angle data 122 to determine the angular difference. If the implement 12 is determined to be lowered (negative angular difference within about −1 degree and −6 degrees or more), the operator interface control module 112 outputs the first operator interface data 138, which graphically and/or textually indicates that the implement 12 is lowered. The first operator interface data 138 includes the icon data 140 and the value data 142 for rendering the first operator interface 200 (FIGS. 4-6) on the display 62. In this example, the icon data 140 comprises a command to render the icon of the implement 12 as lowered, and the value data 142 is the determined negative angular difference that the implement 12 is below the calibrated level position 130. The value data 142 may also include instructions to render a symbol, such as an arrow, which points downward, based on the determination that the implement 12 is lowered.

With reference to FIG. 4, an exemplary one of the first operator interfaces 200 generated by the operator interface control module 112 and rendered on the display 62 is shown. In this example, the first operator interface 200 includes an icon 202 rendered based on the icon data 140 as level. The icon 202 is a side profile of a fork; however, it ii will be understood that any suitable icon may be employed, and further, in various embodiments, the icon data 140 may include a command to render the icon 202 based on the type of implement received via the input data 136.

With reference to FIG. 5, an exemplary one of the first operator interfaces 200 generated by the operator interface control module 112 and rendered on the display 62 is shown. The first operator interface 200 includes the icon 202 rendered based on the icon data 140 as raised. The first operator interface 200 also includes a symbol 204, such as the arrow, which is rendered based on the value data 242 as positive angular difference. The first operator interface 200 also includes a numerical angular value 206, which is also rendered based on the value data 242.

With reference to FIG. 6, an exemplary one of the first operator interfaces 200 generated by the operator interface control module 112 and rendered on the display 62 is shown. The first operator interface 200 includes the icon 202 rendered based on the icon data 140 as lowered. The first operator interface 200 also includes a symbol 208, such as an arrow, which is rendered based on the value data 242 as negative angular difference. The first operator interface 200 also includes the numerical angular value 206, which is also rendered based on the value data 242.

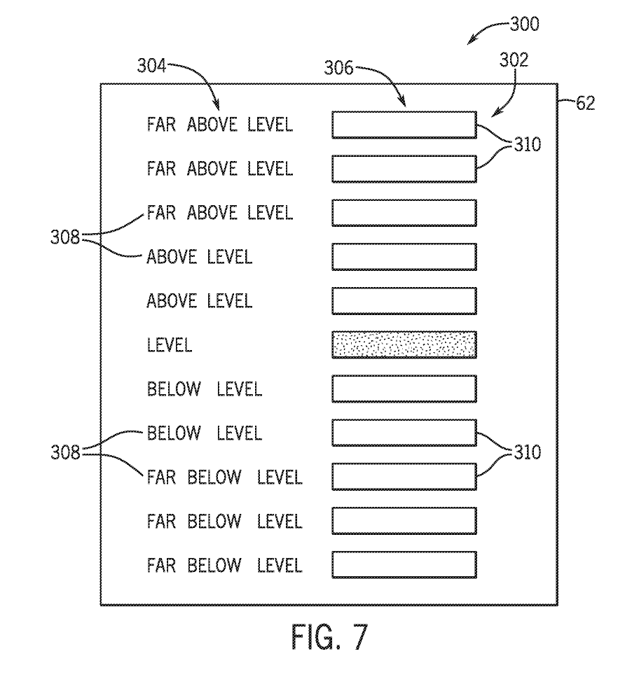

With reference back to FIG. 3, in another embodiment, the operator interface control module 112 receives as input the angle data 122. Based on the angle data 122, the operator interface control module 112 retrieves the position display values 132, including the calibrated level position 130, from the values datastore 110. The operator interface control module 112 compares the angle data 122 to the calibrated level position 130 and determines whether the implement 12 is level as defined by the operator. In one example, the operator interface control module 112 subtracts the calibrated level position 130 from the received angle data 122 to determine an angular difference. If the implement 12 is determined to be level (within about ±1 degree), the operator interface control module 112 outputs second operator interface data 150, which graphically and/or textually indicates that the implement 12 is level. The second operator interface data 150 includes fill data 152 for rendering a second operator interface 300 (FIGS. 7-9) on the display 62. The fill data 152 is a command to fill or shade a graphical level indicator to illuminate the current angular position of the implement 12 relative to the calibrated level position 130. In this example, the fill data 152 comprises a command to shade the graphical level indicator to illuminate the current angular position as level.

The operator interface control module 112 compares the angle data 122 to the calibrated level position 130 and determines whether the implement 12 is within the threshold range for the third position range (the above level position) or the fourth position range (the far above level position), such as about +1 degree to about +6 degrees (or more), retrieved with the position display values 132. In one example, the operator interface control module 112 subtracts the calibrated level position 130 from the received angle data 122 to determine an angular difference. If the implement 12 is determined to be above level (positive angular difference within about +1 degree and +3 degrees), the operator interface control module 112 determines whether the positive angular difference is within the threshold range for the third position range (the above level position) or the fourth position range (the far above level position). For example, the operator interface control module 112 compares the positive angular difference to each of the threshold ranges for the third position range and the fourth position range, and to each of the threshold ranges associated with the sub-ranges for each of these position ranges, to determine the fill data 152. In this example, the operator interface control module 112 determines whether the current angular position of the implement 12 is within the predefined threshold range for the first above level position (about +1 degrees to +2 degrees); whether the current angular position of the implement 12 is within the predefined threshold range for the second above level position (about +2 degrees to +3 degrees); whether the current angular position of the implement 12 is within the predefined threshold range for the first far above level position (about +3 degrees to +4 degrees); whether the current angular position of the implement 12 is within the predefined threshold range for the second far above level position (about +4 degrees to +5 degrees); and whether the current angular position of the implement 12 is within the predefined threshold range for the third far above level position (about +5 degrees to +6 degrees).

Based on this comparison, the operator interface control module 112 outputs the second operator interface data 150, which graphically and/or textually indicates that the implement 12 is above level (first above level position or second above level position) or far above level (first far above level position, second far above level position or third far above level position). The second operator interface data 150 includes the fill data 152 for rendering the second operator interface 300 (FIGS. 7-9) on the display 62. In this example, the fill data 152 comprises a command to shade the graphical level indicator to illuminate the current angular position as above level (first above level position or second above level position) or far above level (first far above level position, second far above level position or third far above level position) based on the results of the comparison.

The operator interface control module 112 also compares the angle data 122 to the calibrated level position 130 and determines whether the implement 12 is within the threshold range for the first position range (the below level position) or the second position range (the far below level position), such as about −1 degree to about −6 degrees (or more), retrieved with the position display values 132. In one example, the operator interface control module 112 subtracts the calibrated level position 130 from the received angle data 122 to determine an angular difference. If the implement 12 is determined to be below level (negative angular difference within about −1 degree and −6 degrees or more), the operator interface control module 112 determines whether the negative angular difference is within the threshold range for the first position range (the below level position) or the second position range (the far below level position). For example, the operator interface control module 112 compares the negative angular difference to each of the threshold ranges for the first position range and the second position range, and to each of the threshold ranges associated with the sub-ranges for each of these position ranges, to determine the fill data 152. In this example, the operator interface control module 112 determines whether the current angular position of the implement 12 is within the predefined threshold range for the first below level position (about −1 degree to −2 degrees); whether the current angular position of the implement 12 is within the predefined threshold range for the second below level position (about −2 degrees to −3 degrees); whether the current angular position of the implement 12 is within the predefined threshold range for the first far below level position (about −3 degrees to −4 degrees); whether the current angular position of the implement 12 is within the predefined threshold range for the second far below level position (about −4 degrees to −5 degrees); and whether the current angular position of the implement 12 is within the predefined threshold range for the third far below level position (about −5 degrees to −6 degrees).

Based on this comparison, the operator interface control module 112 outputs the second operator interface data 150, which graphically and/or textually indicates that the implement 12 is below level (first below level position or second below level position) or far below level (first far below level position, second far below level position or third far below level position). The second operator interface data 150 includes the fill data 152 for rendering the second operator interface 300 (FIGS. 7-9) on the display 62. In this example, the fill data 152 comprises a command to shade the graphical level indicator to illuminate the current position as below level (first below level position or second below level position) or far below level (first far below level position, second far below level position or third far below level position) based on the results of the comparison.

With reference to FIG. 7, an exemplary one of the second operator interfaces 300 generated by the operator interface control module 112 and rendered on the display 62 is shown. In this example, the second operator interface 300 includes a graphical level indicator 302. The graphical level indicator 302 includes two columns 304, 306. The column 304 has a plurality of textual labels 308, which correspond to a respective one of a plurality of boxes 310 of the column 306. The textual labels 308 include, but are not limited to, “Far Above Level,” “Above Level,” “Level,” “Below Level” and “Far Below Level.” The graphical level indicator 302 is shaded based on the fill data 152. The fill data 152 may also include a color for filling the associated box 310 in the graphical level indicator 302. For example, the fill data 152 may include instructions for a green color fill for level, a yellow color fill for above level and below level; and a red color fill for far above level and far below level. Generally, each box 310 corresponds directly to one of the sub-ranges, such that from a top of the column 306 down, each box is associated respectively with the third far above level position, the second far above level position, the first far above level position, the second above level position, the first above level position, the level position, the first below level position, the second below level position, the first far below level position, the second far below level position and the third far below level position. In this example, the fill data 152 indicates level. The box 310 that corresponds with the label 308 of “Level” on the graphical level indicator 302 is shaded based on the fill data 152. In this example, the implement 12 is 0.5 degrees above the calibrated level position 130.

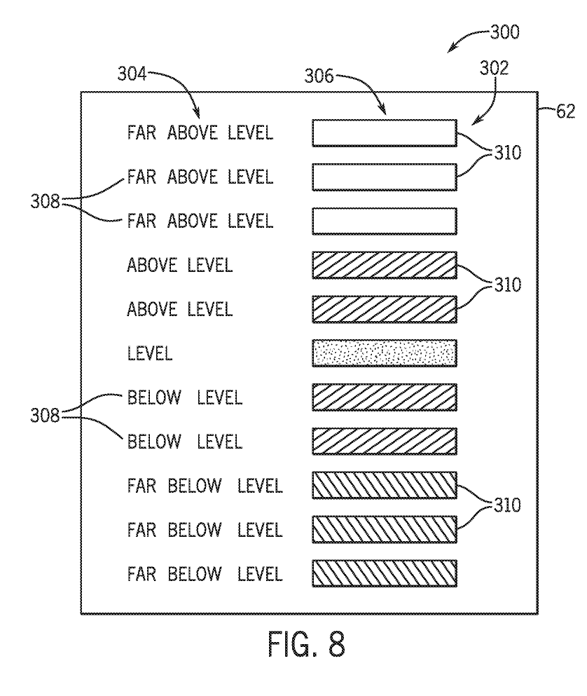

With reference to FIG. 8, an exemplary one of the second operator interfaces 300 generated by the operator interface control module 112 and rendered on the display 62 is shown. The graphical level indicator 302 is shaded based on the fill data 152. In this example, the fill data 152 indicates above level but just below far above level. The graphical level indicator 302 is shaded based on the fill data 152 vertically upward to and including the box 310 that corresponds with the second label 308 of “Above Level.” In this example, the implement 12 is 2.5 degrees above the calibrated level position 130 or in the second above level position.

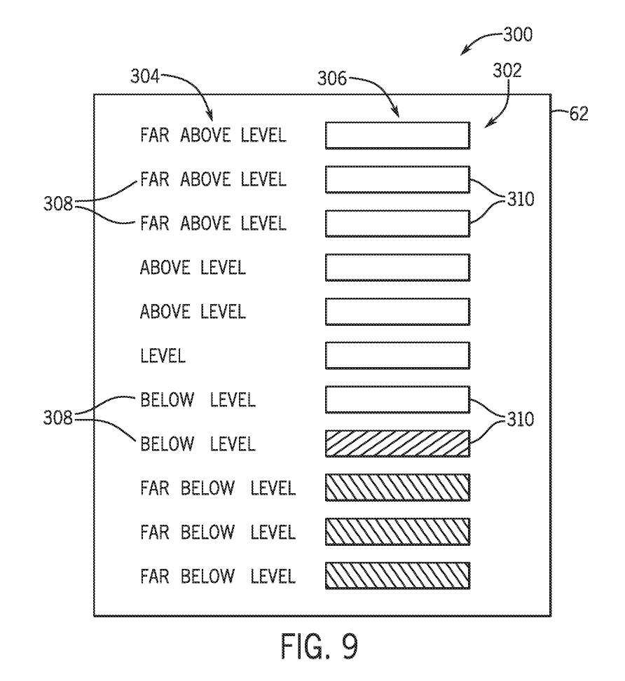

With reference to FIG. 9, an exemplary one of the first operator interfaces 200 generated by the operator interface control module 112 and rendered on the display 62 is shown. The graphical level indicator 302 is shaded based on the fill data 152. In this example, the fill data 152 indicates below level but just above far below level. The graphical level indicator 302 is shaded based on the fill data 152 vertically upward to and including the box 310 that corresponds with the first label 308 of “Below Level.” In this example, the implement 12 is 2.5 degrees below the calibrated level position 130 or in the second below level position.

It should be noted that while the second operator interface 300 (FIGS. 7-9) is illustrated and described herein as comprising a user interface for rendering on the ii display 62, the second operator interface 300 may comprise a plurality of color lights, which receive one or more control signals from the controller 48 to illuminate based on the determined angular position.

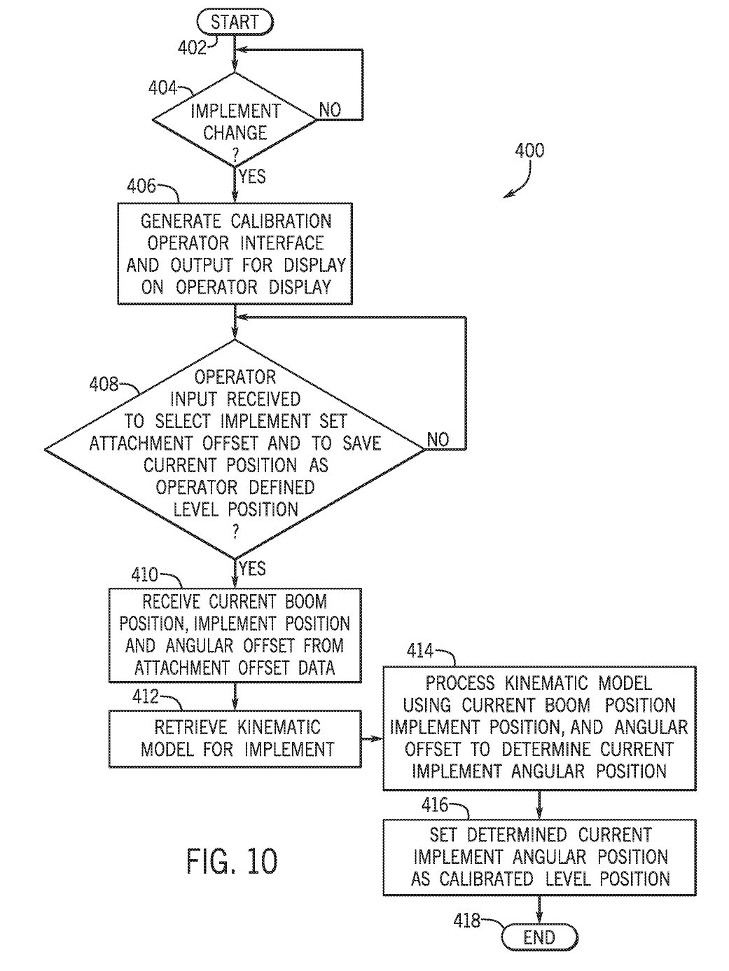

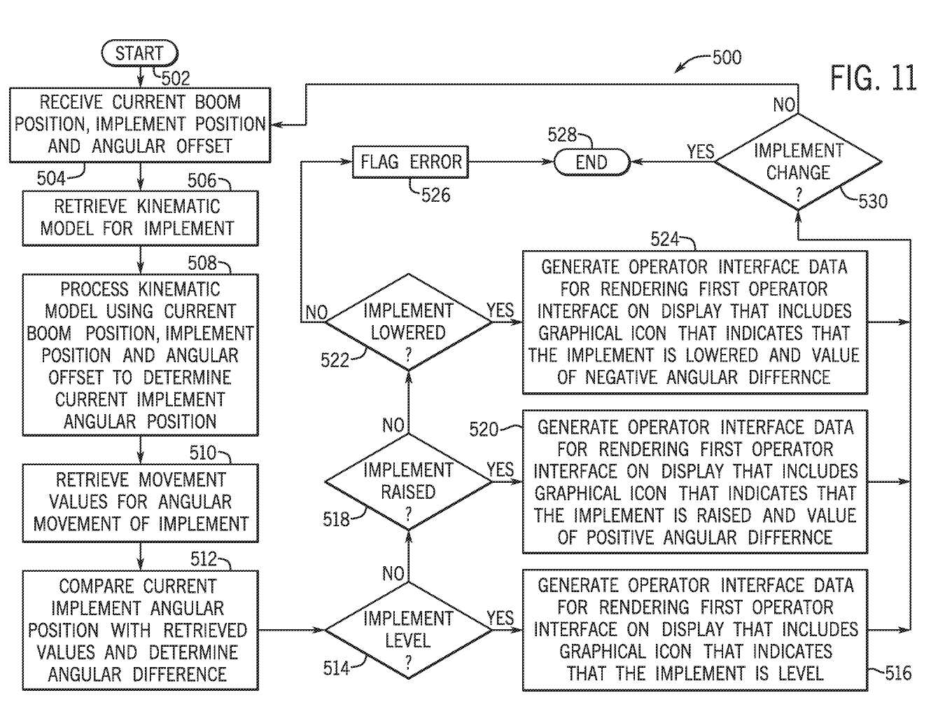

Referring now also to FIG. 10, a flowchart illustrates a calibration method 400 that may be performed by the control module 102 of the controller 48 of FIGS. 1-3 in accordance with the present disclosure. As can be appreciated in light of the disclosure, the order of operation within the method is not limited to the sequential execution as illustrated in FIG. 10, but may be performed in one or more varying orders as applicable and in accordance with the present disclosure.

In various embodiments, the method may be scheduled to run based on predetermined events, and/or can run based on the receipt of implement change data 124.

In one example, the method begins at 402. At 404, the method determines whether the implement change data 124 has been received that indicates that a new implement has been coupled to the loader work vehicle 10. If true, the method proceeds to 406. Otherwise, the method loops.

At 406, the method generates the calibration prompt operator interface data 134 and outputs the calibration prompt operator interface data 134 for rendering on the display 62. At 408, the method determines whether input data 136 has been received, from the human machine interface 56, for example, via one of the joysticks 56a, the buttons 56b or the touchscreen interface 56c, to select the type of implement 12, to set the attachment offset and to save the current angular position of the implement 12 as the operator defined level position. If true, the method proceeds to 410. Otherwise, the method loops.

At 410, the method receives the current position of the first boom 16 and the second boom 18 from the sensors 70 (i.e. the boom position data 116), receives the position of the implement 12 from the sensors 68 (i.e. the implement position data 118) and the angular offset from the attachment offset data 121. Based on the type of implement 12, the method retrieves the kinematic model data 114 for the implement at 412. At 414, the method processes the kinematic model data 114 using the boom position data 116, the implement position data 118 and the attachment offset data 121 to determine the current angular position of the implement 12 (i.e. the angle data 122). At 416, the method sets the current angular position of the implement 12 as the calibrated level position for the implement 12. The method ends at 418.

Referring now also to FIG. 11, a flowchart illustrates a method 500 that may be performed by the control module 102 of the controller 48 of FIGS. 1-3 in accordance with ii the present disclosure to generate the first operator interface 200 (FIGS. 4-6) for rendering on the display 62. Generally, the method 500 is performed after the calibration method 400 of FIG. 10. As can be appreciated in light of the disclosure, the order of operation within the method is not limited to the sequential execution as illustrated in FIG. 11, but may be performed in one or more varying orders as applicable and in accordance with the present disclosure.

In various embodiments, the method may be scheduled to run based on predetermined events, and/or can run based on the receipt of boom position data 116 and/or implement position data 118.

The method beings at 502. At 504, the method receives the current position of the first boom 16 and the second boom 18 from the sensors 70 (i.e. the boom position data 116), receives the position of the implement 12 from the sensors 68 (i.e. the implement position data 118) and receives the angular offset from the attachment offset data 121. At 506, based on the type of implement 12, the method retrieves the kinematic model data 114 for the implement 12. At 508, the method processes the kinematic model data 114 using the boom position data 116, the implement position data 118 and the attachment offset data 121 to determine the current angular position of the implement 12 (i.e. the angle data 122).

At 510, the method retrieves the position display values 132 associated with the angular movement of the implement 12. At 512, the method compares the current angular position of the implement 12 with the retrieved position display values 132, which include the calibrated level position 130, and determines an angular difference between the current angular position of the implement 12 and the calibrated level position 130. At 514, the method determines, based on the comparison, whether the implement 12 is level. Stated another way, the method determines whether the current angular position of the implement 12 (i.e. the angle data 122) matches the operator defined level position (i.e. the calibrated level position 130) or if the angular difference is within about ±1 degree. If true, the method proceeds to 516.

Otherwise, at 518, based on the comparison, the method determines whether the implement 12 is in a raised position. Stated another way, the method determines whether the current angular position of the implement 12 (i.e. the angle data 122) has a positive angular difference from the operator defined level position (i.e. the calibrated level position 130). If true, the method proceeds to 520.

Otherwise, at 522, the method determines, based on the comparison, whether the implement 12 is in a lowered position. Stated another way, the method determines whether the current angular position of the implement 12 (i.e. the angle data 122) has a negative angular difference from the operator defined level position (i.e. the calibrated level position 130). If true, the method proceeds to 524. Otherwise, the method flags an error at 526 and ends at 528.

At 516, the method generates the first operator interface data 138 for rendering the first operator interface 200 (FIGS. 4-6) on the display 62, which includes the icon data 140 that graphically illustrates that the implement 12 is level. The method proceeds to 530. At 530, the method determines whether the implement 12 has changed, based on the implement change data 124. If true, the method ends at 528. Otherwise, the method loops to 504.

At 520, the method generates the first operator interface data 138 for rendering the first operator interface 200 (FIGS. 4-6) on the display 62, which includes the icon data 140 that graphically illustrates that the implement 12 is raised and the value data 142 that indicates the determined positive angular difference. The method proceeds to 530.

At 524, the method generates the first operator interface data 138 for rendering the first operator interface 200 (FIGS. 4-6) on the display 62, which includes the icon data 140 that graphically illustrates that the implement 12 is lowered and the value data 142 that indicates the determined negative angular difference. The method proceeds to 530.

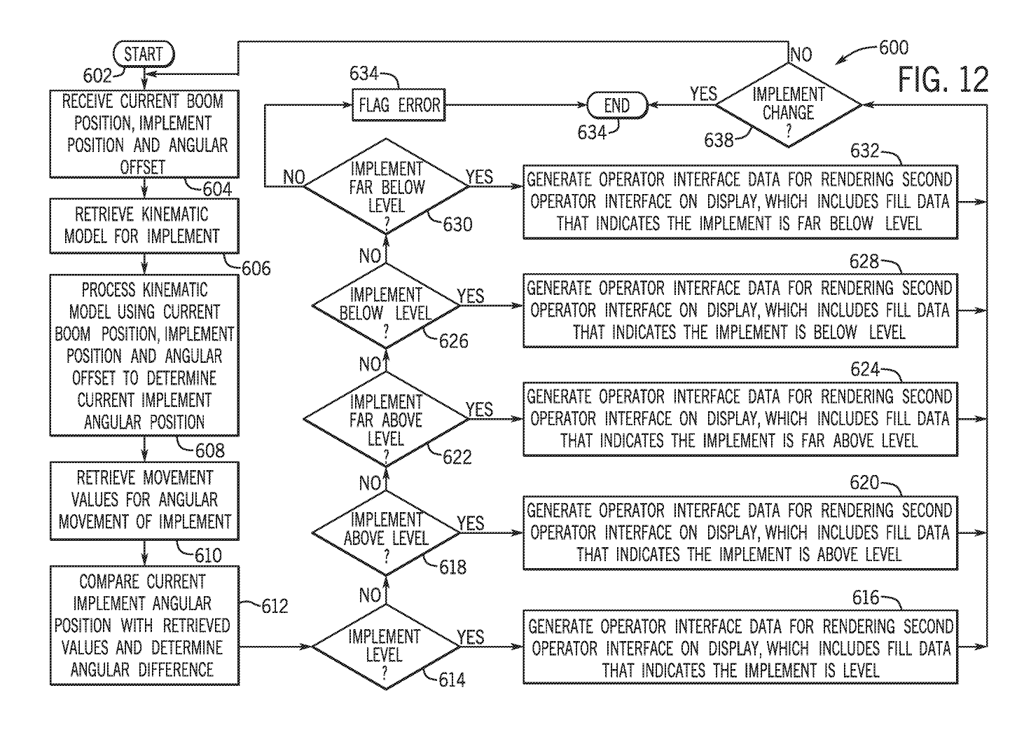

Referring now also to FIG. 12, a flowchart illustrates a method 600 that may be performed by the control module 102 of the controller 48 of FIGS. 1-3 in accordance with the present disclosure to generate the second operator interface 300 (FIGS. 7-9) for rendering on the display 62. Generally, the method 600 is performed after the calibration method 400 of FIG. 10. As can be appreciated in light of the disclosure, the order of operation within the method is not limited to the sequential execution as illustrated in FIG. 12, but may be performed in one or more varying orders as applicable and in accordance with the present disclosure.

In various embodiments, the method may be scheduled to run based on predetermined events, and/or can run based on the receipt of boom position data 116 and/or implement position data 118.

The method beings at 602. At 604, the method receives the current position of the first boom 16 and the second boom 18 from the sensors 70 (i.e. the boom position data 116), receives the position of the implement 12 from the sensors 68 (i.e. the implement position data 118) and receives the angular offset of the implement 12 from the attachment offset data 121. At 606, based on the type of implement 12, the method retrieves the kinematic model data 114 for the implement 12. At 608, the method processes the kinematic model data 114 using the boom position data 116, the implement position data 118 and the attachment offset data 121 to determine the current angular position of the implement 12 (i.e. the angle data 122). At 610, the method retrieves the position display values 132 associated with the angular movement of the implement 12. At 612, the method compares the current angular position of the implement 12 with the retrieved position display values 132 and determines an angular difference between the current angular position of the implement 12 and the calibrated level position 130. At 614, the method determines, based on the comparison, whether the implement 12 is level. Stated another way, the method determines whether the current angular position of the implement 12 (i.e. the angle data 122) matches the operator defined level position (i.e. the calibrated level position 130). If true, the method proceeds to 616.

Otherwise, at 618, based on the comparison, the method determines whether the current angular position of the implement 12 is within the threshold range for the third position range retrieved with the position display values 132. Stated another way, the method determines whether the current angular position of the implement 12 (i.e. the angle data 122) is within the predefined threshold range for the above level position, such as about +1 to +3 degrees. In various embodiments, the method determines whether the current angular position of the implement 12 is within the predefined threshold range for the first above level position (about +1 degrees to +2 degrees); and whether the current angular position of the implement 12 is within the predefined threshold range for the second above level position (about +2 degrees to +3 degrees). If true, the method proceeds to 620.

Otherwise, at 622, based on the comparison, the method determines whether the current angular position of the implement 12 is within the threshold for the fourth position range retrieved with the position display values 132. Stated another way, the method determines whether the current angular position of the implement 12 (i.e. the angle data 122) is within the predefined threshold range for the far above level position, such as about +3 to +6 degrees or more. In various embodiments, the method determines whether the current angular position of the implement 12 is within the predefined threshold range for the first far above level position (about +3 degrees to +4 degrees); whether the current angular position of the implement 12 is within the predefined threshold range for the second far above level position (about +4 degrees to +5 degrees); and whether the current angular position of the implement 12 is within the predefined threshold range for the third far above level position (about +5 degrees to +6 degrees). If true, the method proceeds to 624.

Otherwise, at 626, based on the comparison, the method determines whether the ii current angular position of the implement 12 is within the threshold for the first position range retrieved with the position display values 132. Stated another way, the method determines whether the current angular position of the implement 12 (i.e. the angle data 122) is within the predefined threshold range for the below level position, such as about −1 to −3 degrees. In various embodiments, the method determines whether the current angular position of the implement 12 is within the predefined threshold range for the first below level position (about −1 degree to −2 degrees); and whether the current angular position of the implement 12 is within the predefined threshold range for the second below level position (about −2 degrees to −3 degrees). If true, the method proceeds to 628.

Otherwise, at 630, based on the comparison, the method determines whether the current angular position of the implement 12 is within the threshold for the second position range retrieved with the position display values 132. Stated another way, the method determines whether the current angular position of the implement 12 (i.e. the angle data 122) is within the predefined threshold range for the far below level threshold, such as about −3 to −6 degrees or more. In various embodiments, the method determines whether the current angular position of the implement 12 is within the predefined threshold range for the first far below level position (about −3 degrees to −4 degrees); whether the current angular position of the implement 12 is within the predefined threshold range for the second far below level position (about −4 degrees to −5 degrees); and whether the current angular position of the implement 12 is within the predefined threshold range for the third far below level position (about −5 degrees to −6 degrees). If true, the method proceeds to 632. Otherwise, the method flags an error at 634 and ends at 636.

At 616, the method generates the second operator interface data 150 for rendering the second operator interface 300 (FIGS. 7-9) on the display 62, which includes the fill data 152 that graphically illustrates that the current angular positon of the implement 12 is level. The method proceeds to 638. At 638, the method determines whether the implement 12 has changed, based on the implement change data 124. If true, the method ends at 636. Otherwise, the method loops to 604.

At 620, the method generates the second operator interface data 150 for rendering the second operator interface 300 (FIGS. 7-9) on the display 62, which includes the fill data 152 that graphically illustrates that the current angular positon of the implement 12 is above level, and in various embodiments, the fill data 152 graphically illustrates that the current angular positon of the implement 12 is in the first above level position or the second above level position. The method proceeds to 638.

At 624, the method generates the second operator interface data 150 for rendering the second operator interface 300 (FIGS. 7-9) on the display 62, which includes the fill data 152 that graphically illustrates that the current angular positon of the implement 12 is far above level, and in various embodiments, the fill data 152 graphically illustrates that the current angular positon of the implement 12 is in the first far above level position, the second far above level position or the third far above level position. The method proceeds to 638.

At 628, the method generates the second operator interface data 150 for rendering the second operator interface 300 (FIGS. 7-9) on the display 62, which includes the fill data 152 that graphically illustrates that the current angular positon of the implement 12 is below level, and in various embodiments, the fill data 152 graphically illustrates that the current angular positon of the implement 12 is in the first below level position or the second below level position. The method proceeds to 638.

At 632, the method generates the second operator interface data 150 for rendering the second operator interface 300 (FIGS. 7-9) on the display 62, which includes the fill data 152 that graphically illustrates that the current angular positon of the implement 12 is far below level, and in various embodiments, the fill data 152 graphically illustrates that the current angular positon of the implement 12 is in the first far below level position, the second far below level position or the third far below level position. The method proceeds to 638.

As will be appreciated by one skilled in the art, certain aspects of the disclosed subject matter can be embodied as a method, system (e.g., a work vehicle control system included in a work vehicle), or computer program product. Accordingly, certain embodiments can be implemented entirely as hardware, entirely as software (including firmware, resident software, micro-code, etc.) or as a combination of software and hardware (and other) aspects. Furthermore, certain embodiments can take the form of a computer program product on a computer-usable storage medium having computer-usable program code embodied in the medium.

Any suitable computer usable or computer readable medium can be utilized. The computer usable medium can be a computer readable signal medium or a computer readable storage medium. A computer-usable, or computer-readable, storage medium (including a storage device associated with a computing device or client electronic device) can be, for example, but is not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having ii one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium can be any tangible medium that can contain, or store a program for use by or in connection with the instruction execution system, apparatus, or device.

A computer readable signal medium can include a propagated data signal with computer readable program code embodied therein, for example, in baseband or as part of a carrier wave. Such a propagated signal can take any of a variety of forms, including, but not limited to, electro-magnetic, optical, or any suitable combination thereof. A computer readable signal medium can be non-transitory and can be any computer readable medium that is not a computer readable storage medium and that can communicate, propagate, or transport a program for use by or in connection with an instruction execution system, apparatus, or device.

Aspects of certain embodiments are described herein can be described with reference to flowchart illustrations and/or block diagrams of methods, apparatus (systems) and computer program products according to embodiments of the disclosure. It will be understood that each block of any such flowchart illustrations and/or block diagrams, and combinations of blocks in such flowchart illustrations and/or block diagrams, can be implemented by computer program instructions. These computer program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions can also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions can also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

Any flowchart and block diagrams in the figures, or similar discussion above, can illustrate the architecture, functionality, and operation of possible implementations of systems, methods and computer program products according to various embodiments of the present disclosure. In this regard, each block in the flowchart or block diagrams can represent a module, segment, or portion of code, which includes one or more executable instructions for implementing the specified logical function(s). It should also be noted that, in some alternative implementations, the functions noted in the block (or otherwise described herein) can occur out of the order noted in the figures. For example, two blocks shown in succession (or two operations described in succession) can, in fact, be executed substantially concurrently, or the blocks (or operations) can sometimes be executed in the reverse order, depending upon the functionality involved. It will also be noted that each block of any block diagram and/or flowchart illustration, and combinations of blocks in any block diagrams and/or flowchart illustrations, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. Explicitly referenced embodiments herein were chosen and described in order to best explain the principles of the disclosure and their practical application, and to enable others of ordinary skill in the art to understand the disclosure and recognize many alternatives, modifications, and variations on the described example(s). Accordingly, various embodiments and implementations other than those explicitly described are within the scope of the following claims.

What is claimed is:

1. An operator calibrated implement position display system for a loader work vehicle, the loader work vehicle having a boom and an implement each positionable by hydraulic cylinders actuated by a hydraulic circuit, the system comprising:
a source of position data for the boom and the implement; and
a controller that:
determines an operator defined level position and stores the operator defined level position as a calibrated level position for the implement;
determines, based on the position data, a current position of the implement;
compares the current position of the implement with the calibrated level position; and
generates operator interface data for rendering on a display associated with the loader work vehicle that graphically illustrates the current position of the implement relative to the calibrated level position.

2. The system of claim 1, wherein the controller determines the operator defined level position based on a determination that the implement of the loader work vehicle has changed.

3. The system of claim 2, wherein based on the determination that the implement of the loader work vehicle has changed, the controller:
generates calibration operator interface data for rendering on the display;
receives as input an operator request to select the current position of the implement as the operator defined level position;
determines the current position for the implement based on the position data and a kinematic model associated with the implement; and
stores the determined current position for the implement as the calibrated level position.

4. The system of claim 1, wherein the controller compares the current position with the calibrated level position to determine an angular difference between the current position and the calibrated level position.

5. The system of claim 4, wherein the controller generates the operator interface data to include a value of the angular difference for rendering on the display.

6. The system of claim 4, wherein the controller compares the angular difference to at least one threshold to determine whether the implement is one of: level, within a first position range between the calibrated level position and a second position range, and within a third position range between the calibrated level position and a fourth position range.

7. The system of claim 6, wherein the controller generates the operator interface data to include a fill for a graphical level indicator that graphically illustrates that the implement is level, within the first position range, beyond the first position range, within the third position range or beyond the third position range.

8. The system of claim 4, wherein the controller determines the implement is raised based on a positive value for the angular difference.

9. The system of claim 4, wherein the controller determines the implement is lowered based on a negative value for the angular difference.

10. A method for an operator calibrated implement position display system for a loader work vehicle, the loader work vehicle having a boom and an implement each positionable by hydraulic cylinders actuated by a hydraulic circuit, the method comprising:
determining, by a processor, an operator defined level position;
receiving position data for the boom and the implement;
determining, by the processor, based on the position data and a kinematic model for the implement, a current position of the implement;
comparing, by the processor, the current position of the implement to the operator defined level position; and
generating operator interface data for rendering on a display associated with the loader work vehicle that graphically illustrates the current position of the implement relative to the calibrated level position.

11. The method of claim 10, further comprising determining, by the processor, whether the implement of the loader work vehicle has changed and determining the operator defined level position based on the determination that the implement has changed.

12. The method of claim 11, wherein based on the determination that the implement of the loader work vehicle has changed, the method further comprises:
generating, by the processor, calibration operator interface data for rendering on the display;
receiving as input an operator request to select the current position of the implement as the operator defined level position;
determining, by the processor, the current position for the implement based on the position data and a kinematic model associated with the implement; and
storing, by the processor, the determined current position for the implement as the calibrated level position.

13. The method of claim 10, wherein the comparing the current position with the calibrated level position further comprises determining, by the processor, an angular difference between the current position and the calibrated level position.

14. The method of claim 13, wherein the generating the operator interface data further comprises generating the operator interface data to include a value of the angular difference for rendering on the display.

15. The method of claim 14, further comprising comparing, by the processor, the angular difference to at least one threshold to determine whether the implement is one of:
level, within a first position range between the calibrated level position and a second position range, and within a third position range between the calibrated level position and a fourth position range.

16. The system of claim 15, wherein generating the operator interface data further comprises generating the operator interface data to include a fill for a graphical level indicator that graphically illustrates that the implement is level, within the first position range, beyond the first position range, within the third position range or beyond the third position range.

17. The method of claim 14, further comprising determining, by the processor, the implement is raised based on a positive value for the angular difference.

18. The method of claim 14, further comprising determining, by the processor, the implement is lowered based on a negative value for the angular difference.

19. An operator calibrated implement position display system for a loader work vehicle, the loader work vehicle having a boom and an implement each positionable by hydraulic cylinders actuated by a hydraulic circuit, the system comprising:
a source of position data for the boom and the implement; and
a controller that:
determines an operator defined level position and stores the operator defined level position as a calibrated level position for the implement;
determines, based on the position data, a current position of the implement;
compares the current position of the implement with the calibrated level position;
determines an angular difference between the current position and the calibrated level position based on the comparison; and
generates operator interface data for rendering on a display associated with the loader work vehicle that graphically illustrates the current position of the implement relative to the calibrated level position.

20. The system of claim 19, wherein the controller compares the angular difference to at least one threshold to determine whether the implement is one of:
level, within a first position range between the calibrated level position and a second position range, and within a third position range between the calibrated level position and a fourth position range.
